(19) United States
(12) Patent Application Publication
(10) Pub. No.: US 2012/0079419 A1
(43) Pub. Date: Mar. 29, 2012

(54) GUI PROCESSING APPARATUS, GUI PROCESSING METHOD AND GUI PROCESSING PROGRAM

(75) Inventors: Daisuke Ajitomi, Yokohama-Shi (JP); Kotaro Ise, Kawasaki-Shi (JP); Naoki Esaka, Tokyo (JP); Hiroyuki Aizu, Yokohama-Shi (JP)

(73) Assignee: KABUSHIKI KAISHA TOSHIBA, Tokyo (JP)

(21) Appl. No.: 13/232,323

(22) Filed: Sep. 14, 2011

(30) Foreign Application Priority Data
Sep. 27, 2010 (JP) 2010-216005

(51) Int. Cl. G06F 3/048

(52) U.S. Cl. 715/781

(57) ABSTRACT

A GUI processing apparatus has an operational information receiver configured to receive first GUI operational information for operating a GUI window of a first GUI display apparatus, a synchronous controller configured to generate second GUI operational information for a second GUI display apparatus comprising a GUI window operated synchronously in a state of keeping consistency with display information on the GUI window of the first GUI display apparatus when the GUI window of the first GUI display apparatus is operated based on the first GUI operational information, and an operational information transmitter configured to transmit the second GUI operational information to the second GUI display apparatus.

### CROSS REFERENCE TO RELATED APPLICATIONS

This application is based upon and claims the benefit of priority from the prior Japanese Patent Application No. 216005-2010, filed on Sep. 27, 2010, the entire contents of which are incorporated herein by reference.

### FIELD

Embodiments of the present invention relate to a GUI processing apparatus, a GUI processing method, and a GUI processing program for controlling an operation of a GUI window.

### BACKGROUND

Upon updating a GUI window, there is a known technique to access an external server, as required, in order to acquire GUI information and create a new GUI window by using the acquired GUI information.

However, in this type of known technique, it is impossible to synchronously display a plurality of GUI windows which have operation manners, layouts and designs different from one another depending on apparatuses, while keeping the consistency of displayed data.

### BRIEF DESCRIPTION OF THE DRAWINGS

FIG. 1 is a functional block diagram schematically showing a GUI processing system having a GUI processing apparatus 101, according to a first embodiment of the present invention;

FIG. 2 is a view showing an example of a data structure of GUI information to be stored in a GUI information storage 305;

FIG. 3 is a view showing an example of a data structure of GUI status information to be stored in a GUI status information storage 306;

FIG. 4 is a view showing an example of a data structure of GUI status information to be stored in a GUI synchronous information storage 307;

FIG. 5 is a sequence diagram showing an example of process steps of the GUI processing system of FIG. 1;

FIG. 6 is flowchart showing an example of process steps of a GUI information transmitter 301;

FIG. 7 is a view showing an example of a GUI window;

FIG. 8 is a view showing an example of an HTML file;

FIG. 9 is a view showing an example of a GUI window;

FIG. 10 is a flowchart indicating an example of process steps of a GUI synchronous controller 304 in step S120 of FIG. 5;

FIG. 11 is a sequence diagram of a synchronous process in which GUI display apparatuses 102 and 103 transmit operational information to the GUI processing apparatus 101 almost simultaneously;

FIG. 12 is a functional block diagram schematically showing a GUI processing system having a GUI processing apparatus 101a, according to a second embodiment of the present invention;

FIG. 13 is a functional block diagram schematically showing a GUI processing system having a GUI processing apparatus 101, according to a third embodiment of the present invention;

FIG. 14 is a view showing an example of a data structure of GUI status information in the third embodiment;

FIG. 15 is a view showing an example of a data structure of GUI synchronous information in the third embodiment;

FIG. 16 is sequence diagram in basic principle of a GUI synchronous process in the third embodiment;

FIG. 17 is sequence diagram of process steps in basic principle of a GUI synchronous process in the third embodiment;

FIG. 18 is a flowchart showing the details of process steps of a GUI synchronous controller 304 in the third embodiment;

FIG. 19 is a functional block diagram schematically showing a GUI processing system having a GUI processing apparatus 101, according to a fourth embodiment of the present invention; and

FIG. 20 is a view showing an example of a data structure of GUI information in the fourth embodiment.

### DETAILED DESCRIPTION

Embodiments of the present invention will now be explained with reference to the accompanying drawings.

A GUI processing apparatus according to one embodiment has an operational information receiver configured to receive first GUI operational information for operating a GUI window of a first GUI display apparatus, a synchronous controller configured to generate second GUI operational information for a second GUI display apparatus comprising a GUI window operated synchronously in a state of keeping consistency with display information on the GUI window of the first GUI display apparatus when the GUI window of the first GUI display apparatus is operated based on the first GUI operational information, and an operational information transmitter configured to transmit the second GUI operational information to the second GUI display apparatus.

### First Embodiment

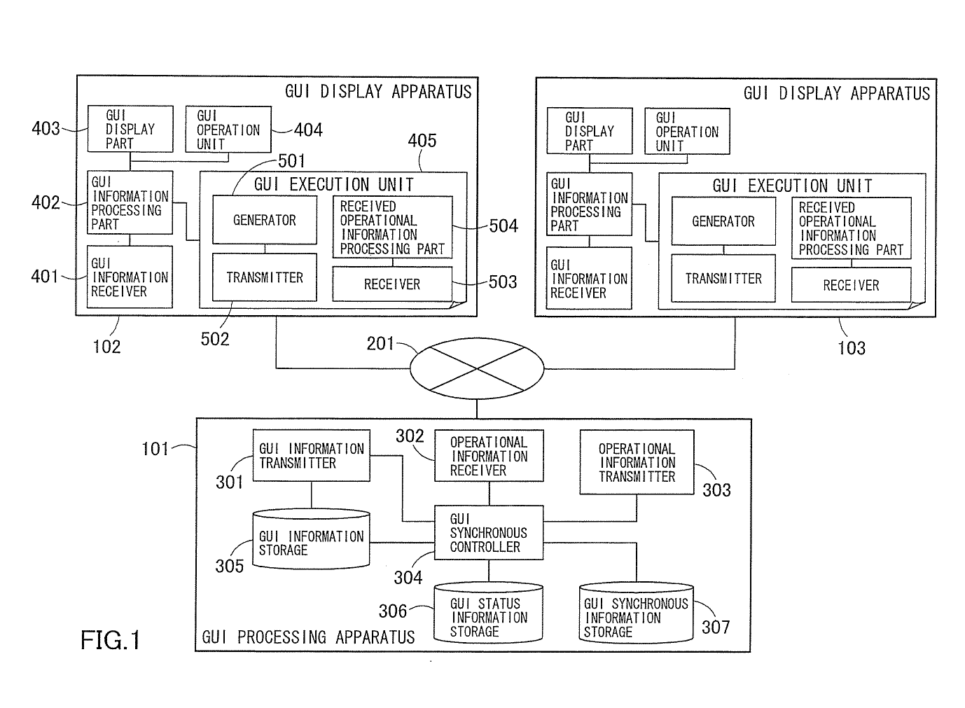

FIG. 1 is a functional block diagram schematically showing a GUI processing system having a GUI processing apparatus 101 according to a first embodiment. The GUI processing system of FIG. 1 is provided with the GUI processing apparatus 101 according to the first embodiment and a plurality of (for example, two) GUI display apparatuses 102 and 103. The GUI processing apparatus 101 and the GUI display apparatuses 102 and 103 perform wireless or wired communications with each other via a network 201.

Functionally, the GUI processing apparatus 101 has a GUI information transmitter 301, an operational information receiver 302, an operational information transmitter 303, a GUI synchronous controller 304, a GUI information storage 305, a GUI status information storage 306, and a GUI synchronous information storage 307.

Each part of the GUI processing apparatus 101 shown in FIG. 1 may be configured with hardware or software. When each part is configured with software, an operation of each part is performed by a specific program executed by a CPU (not shown) in the GUI processing apparatus 101. The operation of each part in the GUI processing apparatus 101 will be described later in detail.

The GUI display apparatuses 102 and 103 basically have the identical internal configuration. Functionally, the GUI display apparatuses 102 and 103 each has a GUI information receiver 401, a GUI information processing part 402, a GUI display part 403, a GUI operation unit 404, and a GUI execution unit 405.

Each part of the GUI display apparatuses 102 and 103 may also be configured with hardware or software. When each part is configured with software, an operation of each part is performed by a specific program executed by a CPU (not shown) in the GUI display apparatus 102. The operation of each part in the GUI display apparatus 102 will be described later in detail.

The hardware configurations of the GUI processing apparatus 101 and the GUI display apparatuses 102 and 103 are not shown. Each apparatus may be provided with a CPU, a RAM as a main memory, a ROM for storing several types of programs to be executed by the CPU, and the like, an auxiliary storage such as an HDD (Hard Disk Drive) for storing several types of data such as GUI information and several types of programs, a bus for connecting these parts one another, and several types of interface parts. These are not indispensable and actual hardware configurations are not be limited to any particular one.

The GUI processing apparatus 101 is, for example, a PC (Personal Computer), a hard disk recorder, a broadband router, an STB (Set Top Box), or a personal server that exist on a home network or a server that exists on the Internet.

The GUI processing apparatus 101 and the GUI display apparatuses 102 and 103 each may be achieved with an electronic device equipped with a CPU for general-purpose PCs or the like. It is indispensable for the GUI display apparatus 102 to have the GUI display part 403 for displaying GUI information and a GUI operation unit 404, such as a key board, for receiving user command inputs. These parts are, however, not indispensable for the GUI processing apparatus101.

The GUI display apparatuses 102 and 103 are, for example, a PC, a digital TV, and a mobile device (such as a smart phone).

In the embodiment described below, an example of the GUI processing apparatus 101 is a digital TV and that of the GUI display apparatuses 102 and 103 is a smart phone.

The network 201 provided between the GUI processing apparatus 101 and the GUI display apparatuses 102 and 103 is, for example, a wired or a wireless home network, the Internet or an NGN (Next Generation Network) that is a quality-guaranteed closed network. It is supposed in this embodiment that the network 201 is a LAN as a home network.

Described next is the internal configurations of the GUI processing apparatus 101 and the GUI display apparatuses 102 and 103 shown in FIG. 1. The information transmitter 301, the operational information receiver 302, the operational information transmitter 303, and the GUI synchronous controller 304 in the GUI display apparatus 101 can be generated on a main memory such as a RAM when a CPU executes a program.

The GUI information storage 305, the GUI status information storage 306, and the GUI synchronous information storage 307 are, for example, a database management system structured on a main memory or an auxiliary storage (not shown). The database management system may be a relational database or an XML (Extensible Markup Language) database. Moreover, the system may not necessarily be a single database management system but may be structured by a plurality of database management systems, for example, SQLite3, Oracle and MySQL. Furthermore, the system may be structured on one physical storage or may be a single database management system composed of a plurality of physical auxiliary storages, such as NAS (Network Attached Storage) and SAN (Storage Area Network). The data storage area may be non-volatile or volatile. Or, the database management system may be a list-based simple data management module that is generated on a main memory when a CPU executes a program, a CSV-format file management module, or a Key/Value store, if it is provided with a means for acquiring unit information (entry) of data stored in each storage.

The GUI information receiver 401, the GUI information processing part 402, the GUI display part 403, and the GUI operation unit 404 in the GUI display apparatus 102 are created on a main memory such as a RAM when a CPU executes a program. Among the parts, the GUI display part 403 may be an instruction set of an output process to a display device such as a liquid crystal display, directed to dedicated hardware such as a GPU (Graphic Processing Unit).

The GUI execution unit 405 is dynamically generated on a main memory by executing GUI information. The GUI execution part 405 has a generator 501, a transmitter 502, a receiver 503, and a received operational information processing part 504.

The GUI information is necessary for generating a GUI window to be displayed by the GUI display part 403 and for reflecting user operation events inputted via the GUI operation unit 404 on the GUI window. The GUI information in this embodiment includes operation-target information to be displayed on a plurality of windows in synchronization with one another. The operation-target information is, for example, a list of information of multimedia contents such as videos, music, and news articles. The contents of information may, however, not to be limited to any particular one, as far as it can be displayed on a plurality of GUI display apparatuses 102 in synchronization with one another.

The GUI information may, for example, be Web contents described in an HTML (Hyper Text Markup Language) file, a JavaScript file, etc. or Flash contents. The GUI information is not limited to the existing Web contents. Its information may be GUI information based on another markup language such as XML and BML (Broadcast Markup Language) and a program description Language except for JavaScript.

Therefore, the generator 501, the transmitter 502, the receiver 503, the received operational information processing part 504 obtained by executing GUI information by the GUI execution unit 405 are functions described, for example, by a JavaScript program included in the GUI information and are functions generated by a JavaScript interpreter when the GUI execution unit 405 executes the GUI information.

The parts dynamically generated on a main memory by executing GUI information at the GUI execution unit 405 will be described hereinbelow in detail.

The generator 501 receives user operational events inputted from the GUI operation unit 404 via the GUI information processing part 402 and generates operational information. The operational information is used for determining subsets of operation-target information to be displayed on a GUI window from a main set of operation-target information that can be displayed on a GUI window, as a result of operation. If the operation-target information is list information of multimedia contents, the operational information may, for example, be composed of a display start index number and the number to be displayed. Moreover, the operational information may include sorting conditions for determining the order to be displayed in the contents list.

A specified example of the operational information is the information expressing “from the most recently updated first item to the tenth item”. Moreover, the operational information may be absolute-value information for determining subsets directly from a main set of operation-target information or relative-value information for obtaining difference information from currently displayed subsets. In the case of the latter relative-value information, the operational information may include only difference information on display start index numbers when the operation-target information is list information on multimedia contents.

The transmitter 502 transmits operational information generated by the generator 501 to the operational information receiver 302. The receiver 503 receives operational information generated on another GUI display apparatus 102 and transmitted from the operational information transmitter 303.

The received operational information processing part 504 processes the operational information received by the receiver 503, determines subsets of operation-target information to be displayed, and transmits the subsets to the GUI display part 403 via the GUI information processing part 402, thus reflecting the subsets on a GUI window.

Described next in detail is each part in the GUI processing apparatus 101. The GUI information transmitter 301, for example, receives a GUI information acquisition request from the GUI information receiver 401 of the GUI display apparatus 102 to acquire GUI information that meets the contents of the request from the GUI information storage 305, and transmits the acquired GUI information to the GUI information receiver 401. The GUI information acquisition request from the GUI information receiver 401 actually includes a GUI information identifier and identification information on the GUI display apparatus 102. The GUI information identifier is used for uniquely identifying the GUI information. It is, for example, a URI (Uniform Resource Identifier). The identification information on the GUI display apparatus 102 is required for composing a GUI window suitable for the GUI display apparatus 102. The identification information is, for example, the display size, the resolution, Web browser identification (User-Agent) information, and the type of the GUI display apparatus 102. The GUI information transmitter 301 is realized, for example, into an HTTP (Hypertext Transfer Protocol) server.

The GUI information storage 305 stores GUI information, and then outputs the GUI information that agrees with the GUI information identifier and the identification information on the GUI display apparatus 102 both included in a request from the GUI information transmitter 301.

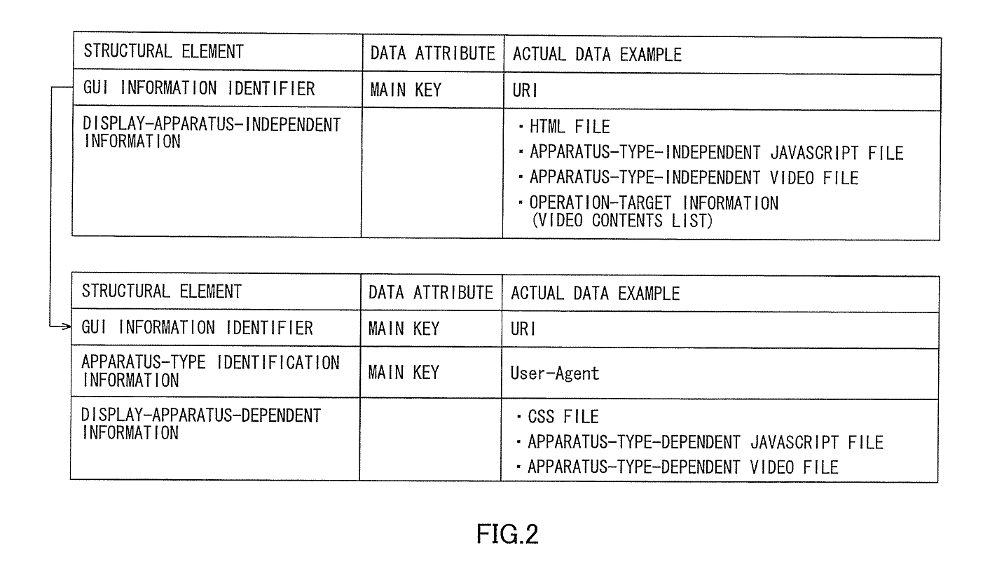

FIG. 2 is a view showing an example of a data structure of GUI information to be stored in the GUI information storage 305. The GUI information is classified into display-apparatus-dependent information that depends on the type of the GUI display apparatus 102 and display-apparatus-independent information that does not depend on the type of the GUI display apparatus 102. The GUI information storage 305 stores a GUI information identifier corresponding to the display-apparatus-independent information together with the display-apparatus-independent information as a pair. Moreover, the GUI information storage 305 stores a GUI information identifier corresponding to the display-apparatus-dependent information and apparatus identification information together with the display-apparatus-dependent information as a pair.

The display-apparatus-dependent information is composed of, for example, a CSS (Cascading Style Sheet) file or a parts file for displaying video data. The display-apparatus-independent information is composed of, for example, an HTML file and a JavaScript file. The HTML file may be classified into the display-apparatus-dependent information which depends on configuration or realization of GUI information.

The operational information receiver 302 receives from the transmitter 502 operational information on the GUI display apparatus 102 and outputs the received operational information to the GUI synchronous controller 304. A specified implementation of the operational information receiver 302 is, for example, an HTTP server or a WebSocket server. It is supposed in this embodiment that the operational information receiver 302 is a WebSocket server.

The operational information transmitter 303 receives operational information and address information on one or more receivers 503 for transmitting the operational information, from the GUI synchronous controller 304 and transmits the operational information to the corresponding receiver 503. A specified implementation of the operational information transmitter 303 is, for example, an HTTP client, an HTTP server, a Comet server, or a WebSocket server. It is supposed in this embodiment that the operational information transmitter 303 is a WebSocket server.

After establishing communication to the transmitter 502 generated in the GUI execution unit 405 in the GUI display apparatuses 102 and 103, the operational information receiver 302 receives GUI operational information transmitted from the transmitter 502. Even after the completion of reception of GUI operational information, the operational information receiver 302 keeps the communication. Or, each time GUI operational information is received, the operational information receiver 302 establishes the communication with the transmitter 502 and then completes the communication after the reception of each GUI operational information.

After establishing communication to the receiver 503 generated in the GUI execution unit 405 in the GUI display apparatuses 102 and 103, the operational information transmitter 303 transmits GUI operational information to the receiver 503. Even after the completion of transmission of GUI operational information, the operational information transmitter 303 keeps the communication. Or, each time GUI operational information is transmitted, the operational information transmitter 303 establishes the communication with the receiver 503 and then completes the communication after the transmission of each GUI operational information.

The condition for keeping the communication even after the completion of transmission of GUI operational information is that the GUI display apparatus does not change as communication destination.

The GUI synchronous controller 304 generates operational information to be transmitted to the receiver 503 in any of the GUI display apparatuses based on the operational information inputted from the operational information receiver 302. Then, the GUI synchronous controller 304 determines a receiver 503 to which the generated operational information is to be transmitted. And, the GUI synchronous controller 304 outputs the generated operational information and address information on the receiver 503 for transmitting the generated operational information, to the operational information transmitter 303. The GUI synchronous controller 304 may use GUI status information stored in the GUI status information storage 306 for determination of operational information. Moreover, the GUI synchronous controller 304 may use GUI synchronous information stored in the GUI synchronous information storage 307 for determination of a receiver 503 to which the generated operational information is to be transmitted.

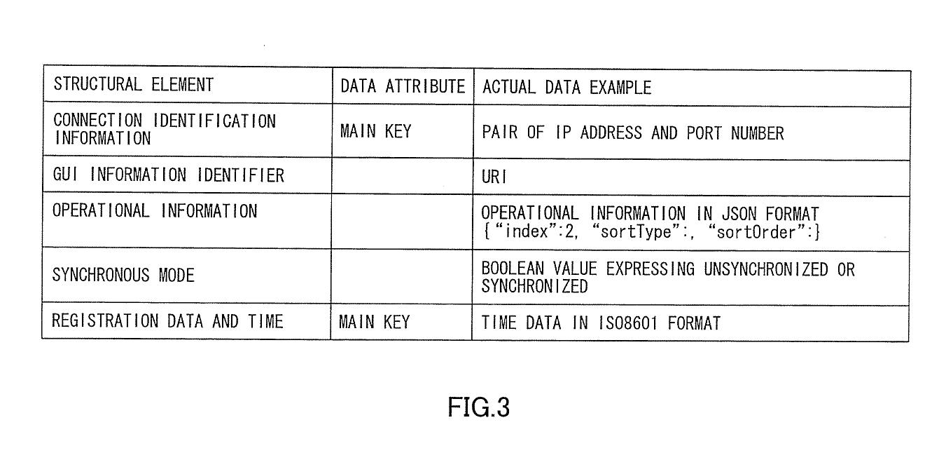

The GUI status information storage 306 stores GUI status information. The GUI status information specifies subsets of operation-target information displayed on the GUI display apparatus 102 or 103 on which operational information is synchronized. FIG. 3 is a view showing an example of a data structure of GUI status information to be stored in GUI status information storage 306. The GUI status information of FIG. 3 includes identification information (for example, a pair of an IP address and a port number) for specifying a connection established with the GUI display apparatus 102 to be synchronized, a GUI identifier, absolute-value operational information, synchronous mode information indicating whether this operational information has already been synchronized or not, and a registered day and time. The GUI status information is, however, not necessarily limited to these information. For example, the GUI identifier is not required if one piece of GUI information has been previously specified. On the other hand, if a plurality of groups of GUI display apparatuses 102 (a synchronous group, hereinafter) on which a GUI window is to be synchronized are allowed to exist, identification information on a synchronous group is required. Moreover, if mode information is not composed by the absolute-value operational information but by relative-value operational information, it is required to keep information for specifying the subsets of operation-target information displayed on a current GUI window.

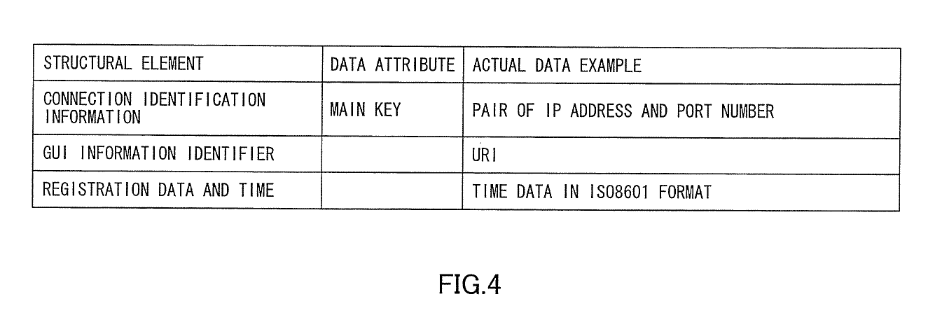

The GUI synchronous information storage 307 stores GUI synchronous information. The GUI synchronous information specifies a group of GUI display apparatuses 102 on which a GUI window is to be synchronized. FIG. 4 is a view showing an example of a data structure of GUI status information to be stored in GUI synchronous mode information storage 307. The GUI synchronous information of FIG. 4 includes connection identification information, a GUI information identifier, and a registered day and time. The GUI synchronous information is, however, not necessarily limited to have these information. If a plurality of synchronous groups are allowed to exist, synchronous-group identification information is required.

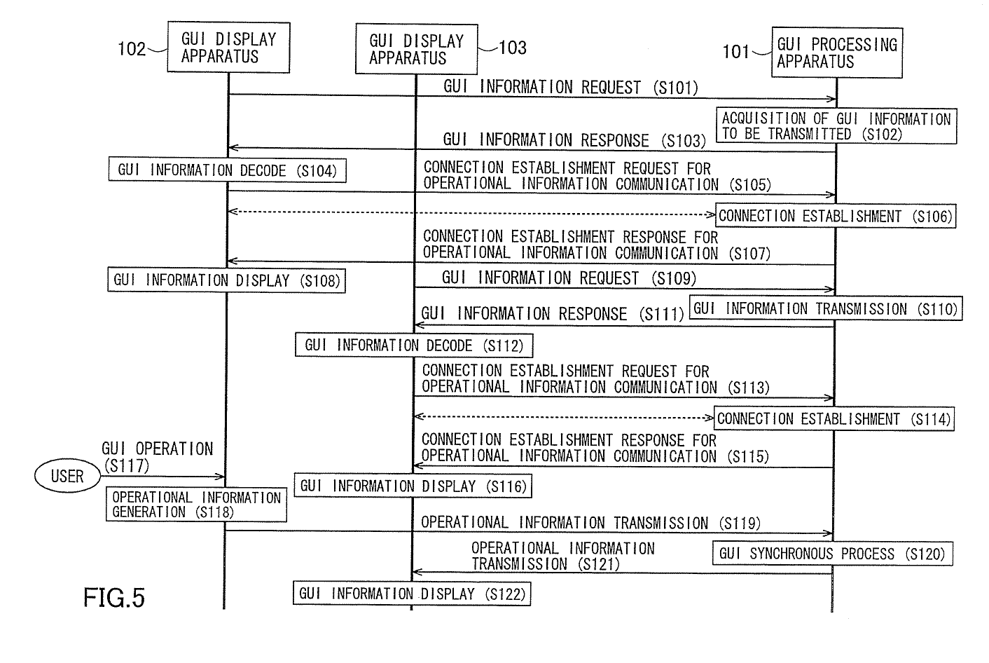

FIG. 5 is a sequence diagram showing an example of process steps of the GUI processing system of FIG. 1. Firstly, the GUI information receiver 401 in the GUI display apparatus 102 transmits a GUI information request message to the GUI information transmitter 301 in the GUI processing apparatus 101 by an HTTP GET method (step S101). An HTTP User-Agent header includes information for specifying the type of the GUI display apparatus 102. An HTTP Request-URI includes GUI information identifier to be displayed on the GUI display apparatus 102. The GUI information transmitter 301 in the GUI processing apparatus 101 receives the request message and determines GUI information that coincides with the apparatus type by using a value of the User-Agent header as a key (step S102). Then, the GUI information transmitter 301 transmits the determined GUI information to the GUI information receiver 401 in response to the HTTP GET request (step S103).

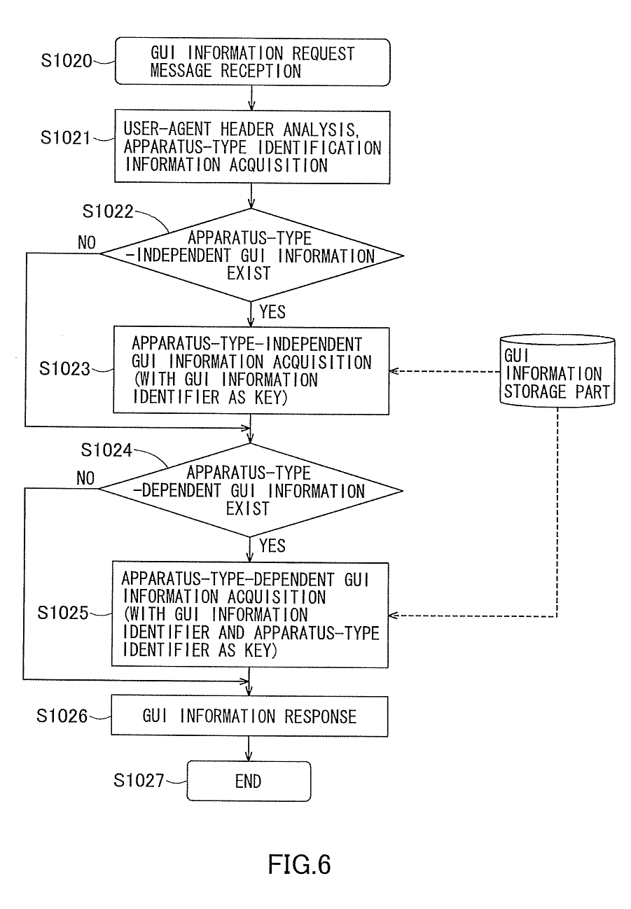

An operation of the GUI information transmitter 301 in step S102 will be explained with reference to a flowchart of FIG. 6. When a GUI information request message from the GUI information receiver 401 is received (step S1020), the GUI information transmitter 301 analyzes a value of the received User-Agent header to extract apparatus-type identification information (step S1021). When there is apparatus-type-independent GUI information (step S1022), the GUI information transmitter 301 acquires the apparatus-type-independent GUI information by using a GUI information identifier included in the received Request-URI (step S1023). Furthermore, when there is apparatus-type-dependent GUI information (step S1024), the GUI information transmitter 301 acquires the apparatus-type-dependent GUI information by using a GUI information identifier and apparatus-type identification information as a key (step S1025). Then, the GUI information transmitter 301 returns the acquired GUI information as a response (step S1026).

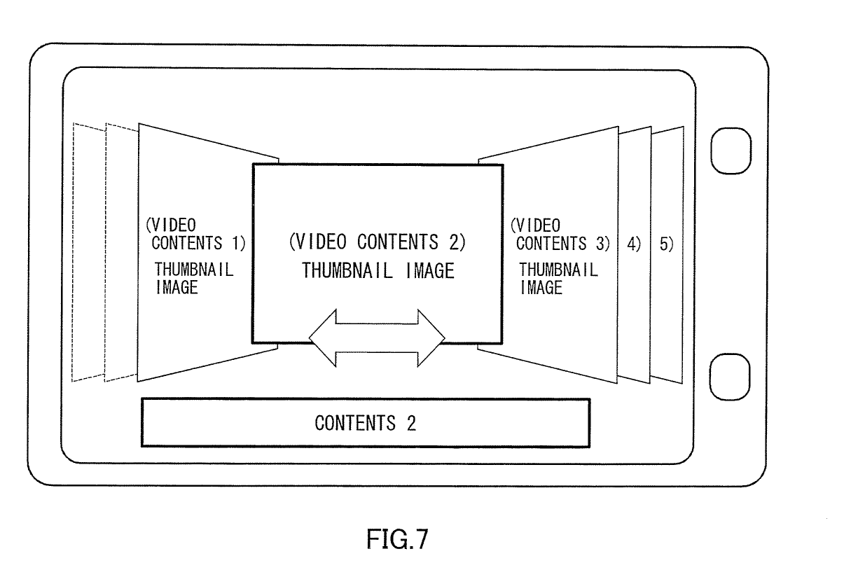

The GUI information returned in step S1026 is necessary for generating a GUI window shown in FIG. 7. The apparatus-type-independent GUI information included in GUI information is composed of an HTML file having <div> tags embedded with a list of video contents information (and a thumbnail file of each video contents). The apparatus-type-dependent GUI information is composed of a CSS file that is used for achieving cover flow through an operation of a touch panel, a JavaScript file, and a group of video files that compose the design for each apparatus type.

Next, the GUI information receiver 401 passes the received GUI information to the GUI information processing part 402 which then decodes the GUI information for displaying the decoded information on a display screen of a display apparatus (step S104). In other words, the GUI information processing part 402 generates a GUI window image from the HTML file, the CSS file, and the video files to be output to the GUI display part 403. Moreover, the GUI information processing part 402 converts the JavaScript codes that include the generator 501, the transmitter 502, the receiver 503, and the received operational information processing part 504 included in the GUI information into an executable binary form by using an interpreter or a JIT (Just In Time) compiler.

When the GUI information is decoded, the transmitter 502 and the receiver 503 send a request of TCP (Transmission Control Protocol) connection establishment for transmitting and receiving operational information to the operational information receiver 302 on the GUI processing apparatus 101 (step S105). The transmitter 502 and the receiver 503 may, separately, send the request for connection establishment. Or, one common request for connection establishment may be sent. In this embodiment, one common request for connection establishment is sent. The request for connection establishment is achieved with an HTTP GET request according to WebSocket protocol.

The operational information receiver 302 receives the request for connection establishment and establishes a TCP connection to be used in bi-directional communication (step S106), and makes a response for the connection establishment (step S107). If the other GUI display apparatus 103 has already established a connection (for example, step S115) at the time of step S107, the operational information receiver 302 acquires GUI status information at this time from the GUI status information storage 306 via the GUI synchronous controller 304 and includes the GUI status information in a response message.

In this embodiment, a connection is established by using WebSocket. Not only to limited to this, common HTTP communication may be used for transmission and HTTP long polling, such as Comet, may be used for reception. Original protocol may also be used. The GUI status information at the time of connection establishment is included in the response message in steps S107 and S115. However, it may be included in the response of GUI information (steps S103, S111). There is no particular limitation practically.

After the establishment of a connection for transmission and reception of operational information, the GUI information processing part 402 outputs the decoded GUI window image to the GUI display part 403. Accordingly, a GUI window is displayed on a touch panel of the GUI display apparatus 102 (step S108).

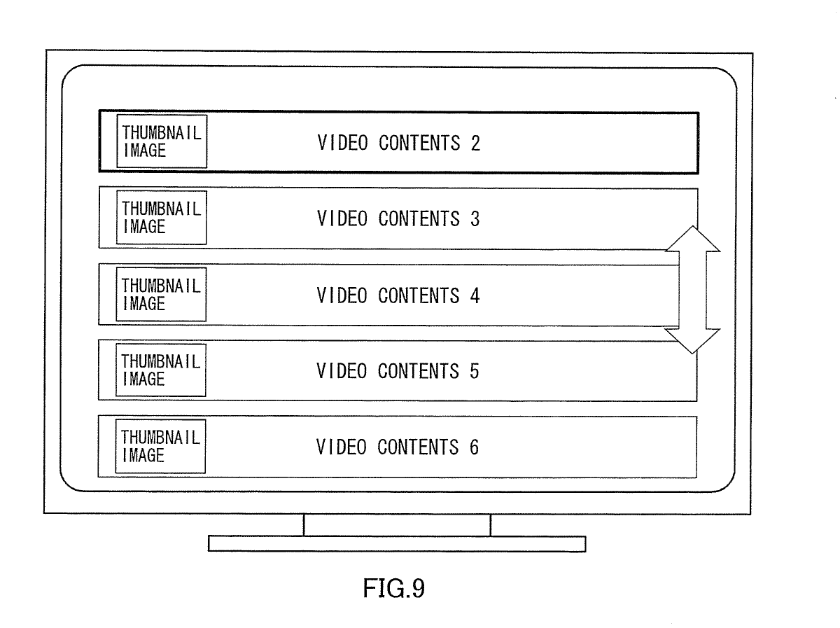

Subsequently, the GUI display apparatus 103 also performs the same process as steps S101 to S108 of the GUI display apparatus 102, thus displaying a GUI window shown in FIG. 9 on a liquid crystal panel (steps S109 to S116).

Then, a user operates a GUI window on the GUI display apparatus (for example, a smart phone) 102 (step S117). Suppose that the user touches a touch panel to scroll a cover-flow contents browser GUI window in FIG. 7 from right to left to change the GUI window from a mode in which “video contents 1” is displayed on the center to another mode in which “video contents 2” is displayed on the center, as shown in FIG. 7. This window change is achieved with apparatus-type-dependent GUI information (CSS and JavaScript codes).

The generator 501 generates information for specifying the set of displayed contents as operational information (step S118). It is expressed, for example, as shown below in JSON (JavaScript Object Notation) format. {“index”:2, “sortType”:, “sortOrder”:}

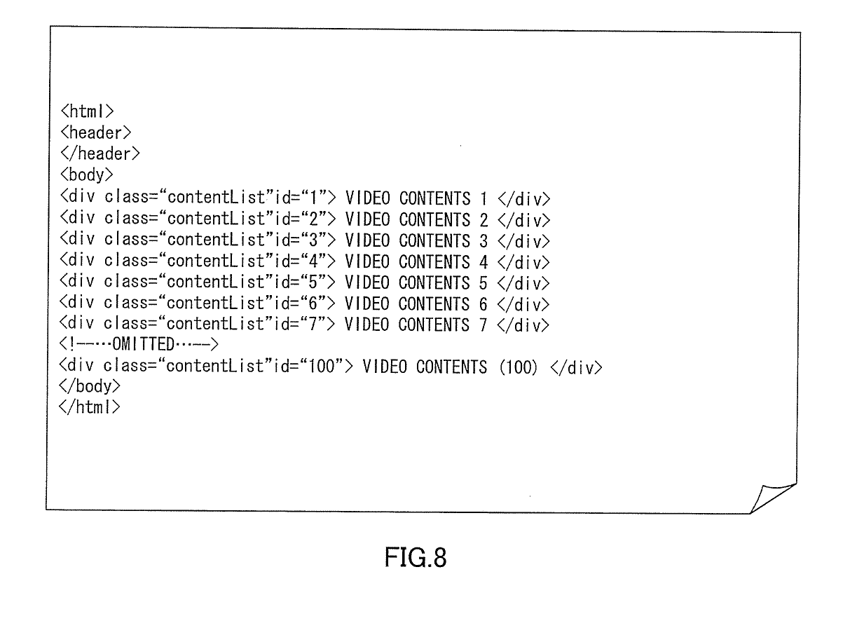

Here, “index” is an ID of the center contents among those displayed on the window, “sortType” is a condition for sorting, and “sortOrder” is a sorting order (ascending or descending order). “index” is an ID attribute value in the contentList classes of FIG. 8. The sorting type and sorting order are not specified here. The sorting type may, for example, be an order of title of video contents, an order of day and time of production, an order of day and time of public view, an order of scale of contents, etc. in a variety of use cases. The operational information is not necessary to be limited to the three attributes. For example, another attribute such as the number of contents to be displayed may be added. Conversely, the condition for sorting may be omitted if not necessary.

The generator 501 transmits the generated operational information to the transmitter 502 which then transmits the operational information to the operational information receiver 302 on the GUI processing apparatus 101 by using the connection established in step S105 (step S119). The operational information receiver 302 transmits the received operational information and identification information (a pair of an IP address and a port number) on the connection to the GUI synchronous controller 304. The GUI synchronous controller 304 specifies the GUI display apparatus 103 (the connection established with the receiver 503 of the GUI display apparatus 103) to be synchronized from the operational information and the connection identification information, to generate operational information for GUI synchronization (step S120). Since the GUI display apparatus 103 has not undergone any user GUI operation, the operational information transmitted by the GUI display apparatus 102 can be used as it is.

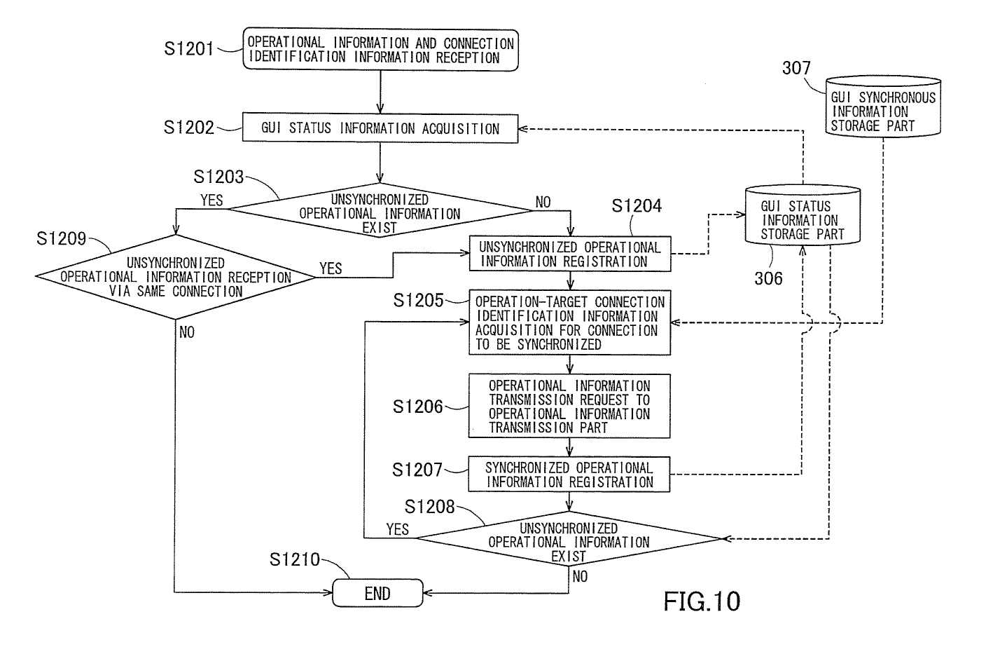

FIG. 10 is a flowchart indicating an example of process steps of the GUI synchronous controller 304 in step S120 of FIG. 5.

When the operational information and the connection identification information is received from the operational information receiver 302 (step S1201), the GUI synchronous controller 304 acquires GUI status information (step S1202) and confirms whether there is operational information (in an unsynchronized mode) that requires synchronization (step S1203).

In this embodiment, when operational information is received from the GUI display apparatus 102, the GUI synchronous controller 304 confirms whether there is operational information which is received from the GUI display apparatus 103 and is not reflected on the GUI display apparatus 102. There is no such operational information in this example. Therefore, the GUI synchronous controller 304 registers the received operational information in the GUI status information storage 306, as a mode of “unsynchronized” (step S1204). Subsequently, the GUI synchronous controller 304 acquires all connection identification information stored in the GUI synchronous information storage 307 (step S1205). The information acquired here is only the connection identification information between the GUI processing apparatus 101 and the GUI display apparatus 103. Subsequently, the GUI synchronous controller 304 requests the operational information transmitter 303 to transmit registered operational information to all of the acquired connections (the connections to the GUI display apparatus 103 only, in this embodiment (step S1206). After the completion of transmission to all of the acquired connections, the GUI synchronous controller 304 changes the mode of operational information registered in the GUI status information storage 306 to “synchronized” (step S1207). And then, the GUI synchronous controller 304 confirms whether there is operational information in the mode of “unsynchronized” still remaining in the GUI status information storage 306 (step S1208).

In this embodiment, there is no such unsynchronized operational information. Therefore, the GUI synchronous controller 304 completes a series of steps to the received operational information (step S1210). If there is such unsynchronized operational information remaining, the GUI synchronous controller 304 returns to the acquiring step (step S1205) of acquiring the connection identification information to the remaining operational information.

The operational information transmitter 303 receives a transmission request for unsynchronized operational information from the GUI synchronous controller 304 and transmits the operational information to the receiver 503 of the GUI display apparatus 103 by using the connection established in step S114 (step S121).

Subsequently, the receiver 503 on the GUI display apparatus 103 transmits the received operational information to the received operational information processing part 504. Lastly, the received operational information processing part 504 analyzes the operational information and changes “video contents 1” displayed on top of a list in a GUI window to “video contents 2” shown in FIG. 9, based on the contents ({“index”:2, “sortType”:, “sortOrder”:}) of the operational information. The change in GUI window may be made with a variety of animations and effectors, such as up scrolling.

The foregoing is a basic process of the GUI display apparatuses 102 and 103 to acquire GUI information for their own types and synchronize the contents of GUI processing.

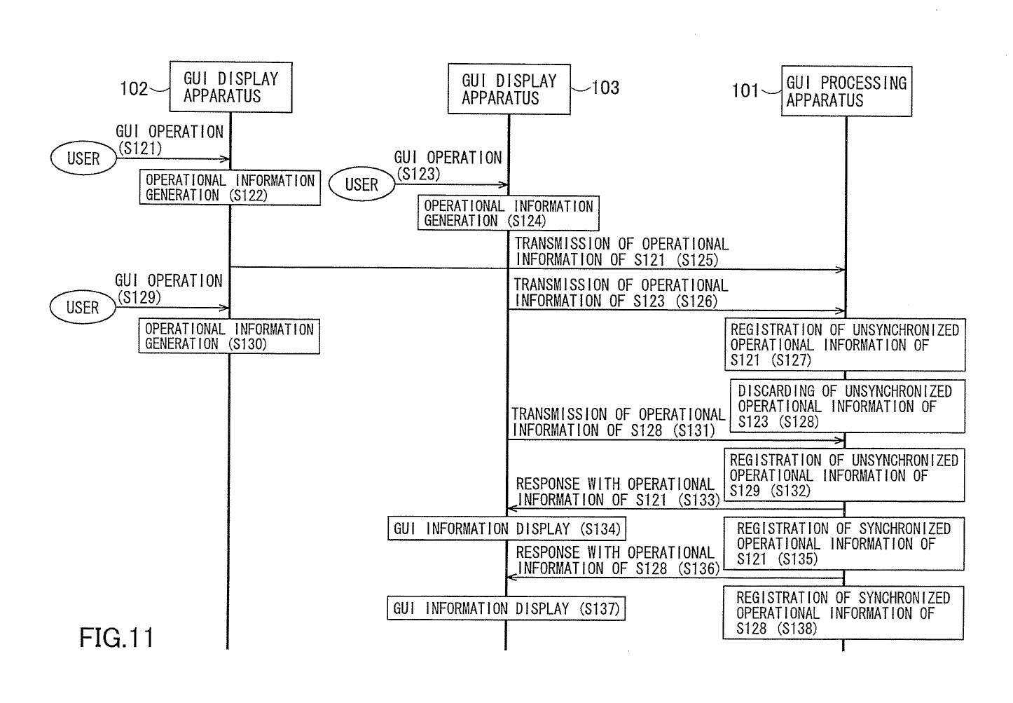

Described next is a synchronization process in which the GUI display apparatuses 102 and 103 transmit operational information to the GUI processing apparatus 101, which occur almost simultaneously. The sequence diagram of this process is shown in FIG. 11. The simultaneous occurrence here means that, after receiving operational information from the GUI display apparatus 102, the GUI processing apparatus 101 receives operational information from the GUI display apparatus 103 before transmitting the operational information received from the GUI display apparatus 102 to the GUI display apparatus 103.

Suppose that a user operates a GUI window on the GUI display apparatus 102 (step S121). Here, the user scrolls the GUI window of FIG. 7 further to the left to change the window so that the video contents 1 is displayed on the center. The operational information generated in this case is {“index”:10, “sortType”:, “sortOrder”:} (step S122). Suppose further that, almost simultaneously, a user operates a GUI window on the GUI display apparatus 103 (step S123) and performs an operation to display the video contents 1 on the center (step S124). The operational information in this case is {“index”:1, “sortType”:, “sortOrder”:}.

Each transmitter 502 in the GUI display apparatuses 102 and 103 transmits the generated operational information to the operational information receiver 302 (steps S125, S126). The process of the GUI synchronous controller 304 is serialized so that even if the operational information receiver 302 receives two pieces of operational information from the GUI display apparatuses 102 and 103 simultaneously, either one of the two pieces of operational information is exclusively processed. The range of exclusive process may cover entire process flow shown in FIG. 10 or the registration process of unsynchronized operational information from steps S1201 to S1208. The range of exclusive process may be set freely as far as there is no inconsistency between the looking-up of unsynchronized operational information (step S1202) and the registration (step S1204) to the GUI status information storage 306.

Suppose that operational information of the GUI display apparatus 102 has firstly been processed by the GUI synchronous controller 304. The operational information of the GUI display apparatus 102 is then registered as unsynchronized operational information in the GUI status information storage 306 (step S127). The operational information of the GUI display apparatus 103 to be processed next is discarded because the unsynchronized operational information from the other apparatus has already been registered (step S128).

The foregoing procedure will be explained with reference to FIG. 10. When the operational information from the GUI display apparatus 103 is processed, the GUI synchronous controller 304 acquires the unsynchronized operational information registered just before, in step S1202. This unsynchronized operational information is the operational information of the GUI display apparatus 102 generated in step S121 of FIG. 11. When there is unsynchronized operational information already registered (step S1203) and it is confirmed that this unsynchronized operational information has not been transmitted from the apparatus of registered unsynchronized operational information (step S1209), the GUI synchronous controller 304 completes the process (step S1210). That operational information is substantially discarded.

Suppose that, before the operational information in step S102 is transmitted to the GUI display apparatus 103, the user further operates a window on the GUI display apparatus 102 (step S129). The generated operational information (for example, {“index”:20, “sortType”:, “sortOrder”:}) is transmitted to the operational information receiver 302 of the GUI processing apparatus 101 (steps S130, S131), and passed to the GUI synchronous controller 304.

A process performed in this embodiment is different from the process for the operational information in step S123. That is, the GUI synchronous controller 304 does not discard the operational information and registers it as unsynchronized operational information to the GUI status information storage 306 (step S132). The registration means step S1209 of FIG. 10 determines that the operational information is generated by the same GUI display apparatus 102 similar to registered unsynchronized operational information. There is high possibility that operational information is generated in succession on the same GUI display apparatus 102. Therefore, the branch process in step S1209 is performed in order to avoid the discarding of successive operational information.

In a stage of receiving operational information three times, the GUI synchronous controller 304 acquires connection identification information for transmitting the unsynchronized operational information registered in step S127. The acquired connection identification information is used for the GUI display apparatus 103. The GUI synchronous controller 304 transmits operational information to the GUI display apparatus 103 via the operational information transmitter 303 (step S133). In accordance with the received operational information, the GUI display apparatus 103 updates the window so that video contents 10 comes to the top of a list (step S134).

Then, the GUI synchronous controller 304 updates the mode of operational information registered in the GUI status information storage 306 into “synchronized” (step S135) and confirms that whether there is unsynchronized operational information in the GUI status information storage 306 (step S1208 in FIG. 10). Since operational information has been registered in step S129, the GUI synchronous controller 304 acquires the connection identification information corresponding to this operational information and transmits the operational information to the GUI display apparatus 103 (step S136). In accordance with the received operational information, the GUI display apparatus 103 displays video contents 20 on top of the list (step S137). Lastly, the GUI synchronous controller 304 updates the mode of this operational information into “synchronized” (step S138) and completes the process.

Finally, displayed on the window of the GUI display apparatus 102 are, as shown in FIG. 7, video contents 2 in the center and three contents before and after, seven contents in total. In contrast, displayed on the window of the GUI display apparatus 103 are, as shown in FIG. 9, the video contents 2 on the top of the list, five contents in total. Although the area of each displayed contents is different between FIGS. 7 and 9, the highlighted contents are identical to each other, while keeping the consistency of displayed contents.

As described above, in the first embodiment, it is achieved that two GUI windows having different layouts designed differently and operated differently can be synchronized, while keeping the consistency of displayed data, by the GUI processing apparatus 10. Practically, it is achieved that an operation in cover flow GUI with left and right scrolling on a touch panel is reflected on a list type GUI window with up and down scrolling. Moreover, even if there is conflict of operations such as the communications sequence shown in FIG. 11, the consistency of data finally displayed on both windows can be kept. Furthermore, user operations successively occurred on one of the GUI display apparatuses 102 can be reflected on the other GUI display apparatus 102 without discarding of the user operations.

<Variation on Process of GUI Information Transmitter 301>

The process of the GUI information transmitter 301 described above is not limited to that shown in FIG. 6. The GUI information transmitter 301 can be omitted if GUI information has been preinstalled in the GUI display apparatuses 102 and 103, and also connection paths to operational information reception and transmitters on the GUI processing apparatus 101 are directly embedded in the preinstalled GUI information, or a manually- or automatically-settable interface is provided.

Moreover, steps S1022 and S1023 are not necessary if there is no apparatus-type-independent GUI information.

Furthermore, FIG. 6 shows a sequence of batch processing of response with acquired GUI information. An actual method is, however, not limited to this. Data that composes a GUI window are generally composed of a plurality of files, such as videos, stile sheets, and JavaScript codes. Therefore, it is preferable that the GUI information receiver 401 transmits a GUI information acquisition request message for each file. Then, the message-accepting GUI information transmitter 301 may divide GUI information into a plurality of pieces of information in accordance with the request message to make a response with GUI information that matches the apparatus type. In this case, a Request-URI of a GUI information acquisition request message indicates one file that composes each divided GUI information. When the Request-URI is generated differently for apparatus types, the GUI information transmitter 401 may be arranged to return a requested file. Conversely, when the same Request-URI is generated for different apparatus types, the GUI information transmitter 401 may be arranged to extract an apparatus-type identifier from User-Agent to determine a file with which a response is made based on the apparatus-type identifier. Both of these policies may be used in a response process with one piece of GUI information or either of the polices may be used.

<Variation on Process of GUI Synchronous Controller 304>

The process of the GUI synchronous controller 304 described above is not limited to that shown in FIG. 10. The process to the GUI status information storage 306 aims for registration of an “unsynchronized” mode and updating to a “synchronized” mode. However, for example, it may be registration and elimination of unsynchronized operational information. Moreover, steps S1208 and S1209 may be omitted if there is no necessity for avoiding the discarding of successive operational information generated on one GUI display apparatus 102.

Furthermore, there are a variety of variations in the process from steps S1020 to S1204. The present embodiment is achieved in accordance with a strategy of reflecting the operational information firstly input to the GUI synchronous controller 304 on another apparatus and basically discarding other operational information received until the completion of reflection, under the condition that no unsynchronized operational information exists. However, the latest operational information may be synchronized among a plurality of pieces of operational information input for a constant period of time. All input operational information may be synchronized. In this case, every synchronized operational information is registered in the GUI status information storage 306 and the operational information is transmitted one after another to all of the connections stored in the GUI synchronous information storage 307.

### Second Embodiment

In a second embodiment which will be described below, the function of the GUI display apparatus 102 is provided within the GUI processing apparatus 101. Hereinbelow, the differences of the second embodiment from the first embodiment will be mainly explained, with simple explanation common to both embodiments.

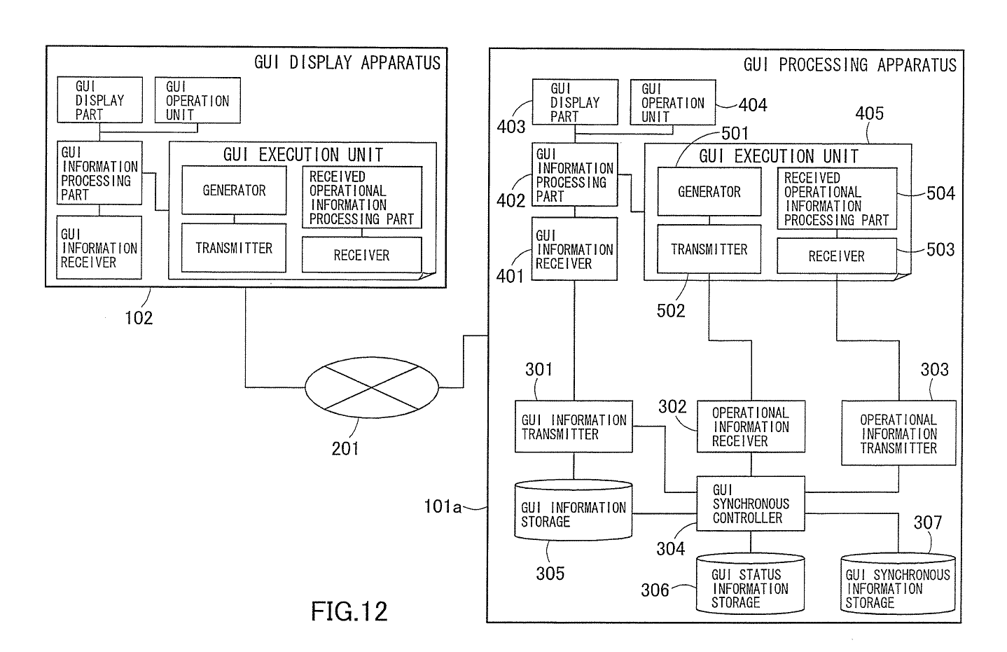

FIG. 12 is a functional block diagram schematically showing a GUI processing system having a GUI processing apparatus 101a, according to the second embodiment. The GUI display apparatus 102 of FIG. 12 is identical to the GUI display apparatus 102 of FIG. 1. However, in FIG. 12, a new GUI processing apparatus 101a is provided to consolidate the GUI processing apparatus 101 and the GUI display apparatus 103 of FIG. 1. An example of practical configuration is a digital TV having the functions of not only the GUI display apparatus 102 but also of the GUI processing apparatus 101.

The process which has been achieved in the first embodiment as the communication by using HTTP protocol or WebSocket protocol between the GUI processing apparatus 101 and the GUI display apparatus 103, is performed at inside of the GUI processing apparatus 101a. The process includes a GUI information transmission process between the GUI information transmitter 301 and the GUI information receiver 401 and an operational information transmission processes between the operational information receiver 302 and the transmitter 502 and between the operational information transmitter 303 and the receiver 503. These processes may be achieved as a communication process like in the first embodiment. Or, the processes may be achieved by more tight connection, such as by memory look-up delivery, with the utilization of functions provided in a single apparatus.

A synchronous process of contents to be displayed on a GUI window between the GUI display apparatus 102 and the GUI processing apparatus 101a is achieved according to the communication sequences of FIG. 5 and FIG. 11, like the first embodiment. However, the process of GUI display apparatus 103 in FIGS. 5 and 11 is implemented in the GUI processing apparatus 101a. In addition, the communication process between the GUI display apparatus 102 and the GUI processing apparatus 101a is achieved with an internal process of the GUI processing apparatus 101a. The process steps of the operational information transmitter 301 and the GUI synchronous controller 304 are performed according to FIG. 6 and FIG. 10, respectively.

As described above, in the second embodiment, the GUI processing apparatus 101a has the function of the GUI display apparatus 103. Therefore, simple and quick data transmission and reception is achieved, with no necessity of communications between the GUI processing apparatus 101a and the GUI display apparatus 103 using any particular protocol, different from FIG. 1. It is also achieved in the second embodiment that two GUI windows having different layouts designed differently and operated differently can be synchronized, while keeping the consistency of displayed data, like the first embodiment.

### Third Embodiment

In a third embodiment which will be described below, a plurality of GUI windows are displayed in synchronization, while keeping the consistency of data, for each given unit group.

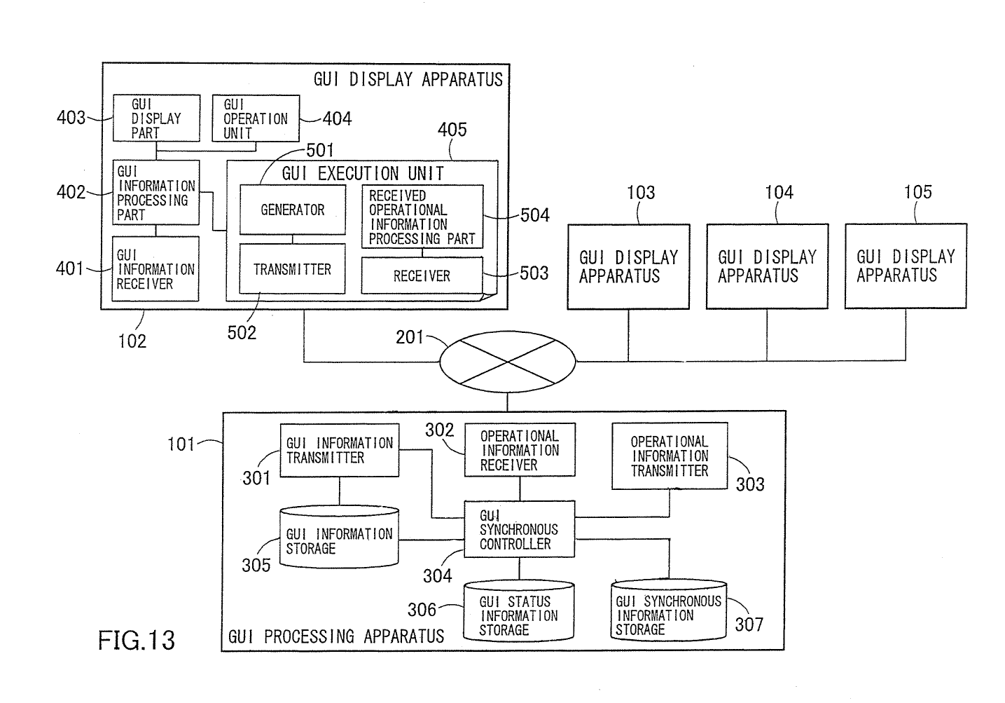

FIG. 13 is a functional block diagram schematically showing a GUI processing system having a GUI processing apparatus 101, according to the third embodiment. With reference to FIG. 13, the differences of the third embodiment from the first and second embodiments will be mainly explained.

The internal configurations of the GUI display apparatus 102 and the GUI processing apparatus 101 of FIG. 13 are basically identical to those of the GUI display apparatus 102 and the GUI processing apparatus 101 of FIG. 1, respectively. Although four GUI display apparatuses 102 are shown in FIG. 13, the number of which is not limited to any particular number.

The processes of the GUI synchronous controller 304, the GUI status information storage 306, and the GUI synchronous information storage 307 in the GUI processing apparatus 101 are different from those of the GUI processing apparatus 101 of FIG. 1. These differences will be mainly explained.

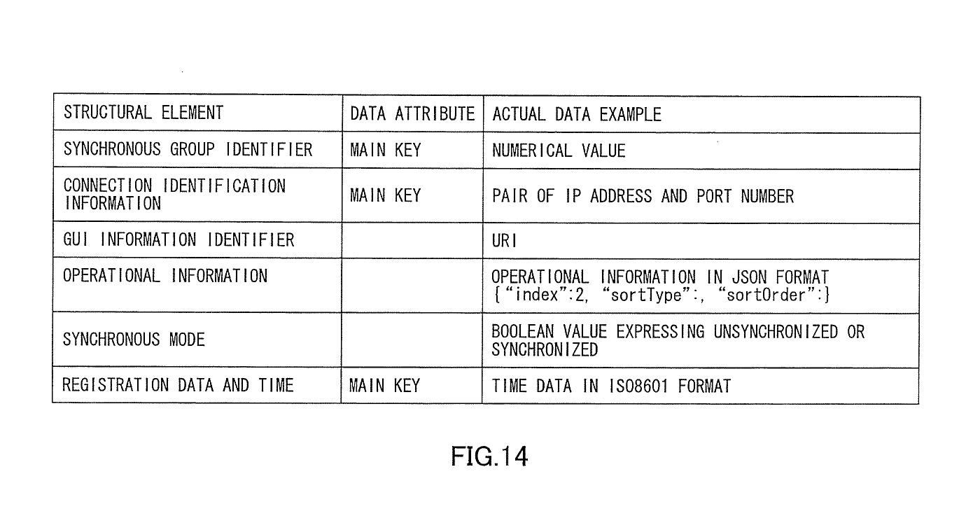

The GUI status information storage 306 stores GUI status information. FIG. 14 is a view showing an example of a data structure of GUI status information in the third embodiment. The GUI status information of FIG. 14 includes an identifier for a group of GUI display apparatuses 102 (synchronous group) on which GUI windows are synchronized with one another, in addition to the GUI status information of FIG. 3 in the first and second embodiments. By means of the identifier, a synchronous group for synchronizing GUI windows is specified and the existence of a plurality of synchronous groups is allowed.

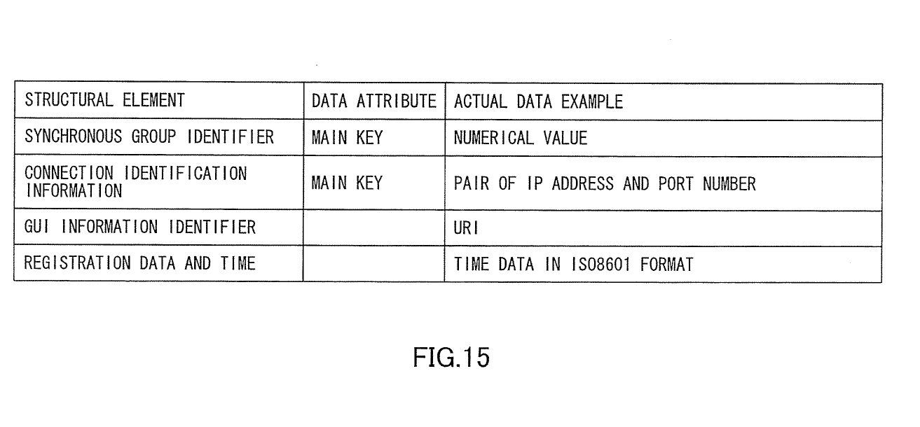

The GUI synchronous information storage 307 stores GUI synchronous information. FIG. 15 is a view showing an example of a data structure of GUI synchronous information in the third embodiment. The GUI synchronous information of FIG. 15 includes a synchronous-group identifier, in addition to the GUI synchronous information of FIG. 4 in the first and second embodiments. By means of the identifier, coexistence of a plurality of synchronous groups is allowed.

The GUI synchronous controller 304 corresponds to the synchronous-group identifiers added to the GUI status information storage 306 and the GUI synchronous information storage 307. The GUI synchronous controller 304 specifies a synchronous group from operational information input from the operational information receiver 302 and transmits the operational information to a GUI display apparatus 102 belonging to the synchronous group.

Described next is an operation of the GUI processing apparatus 101 according to the third embodiment. The GUI information to be stored in the GUI information storage 305 is the same as that of the first and second embodiments, as shown in FIG. 2 for example.

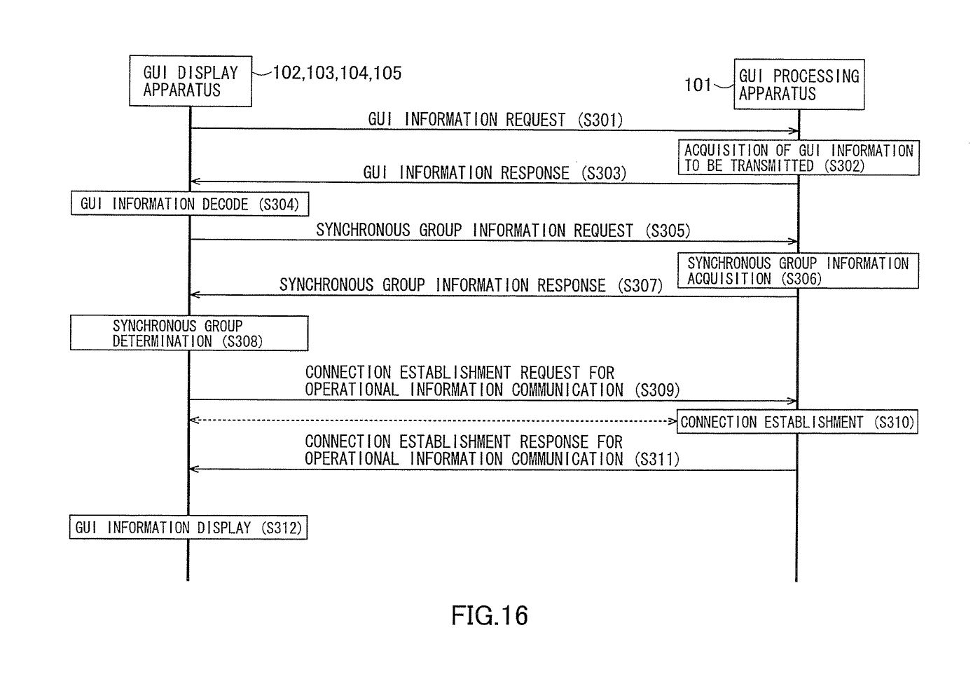

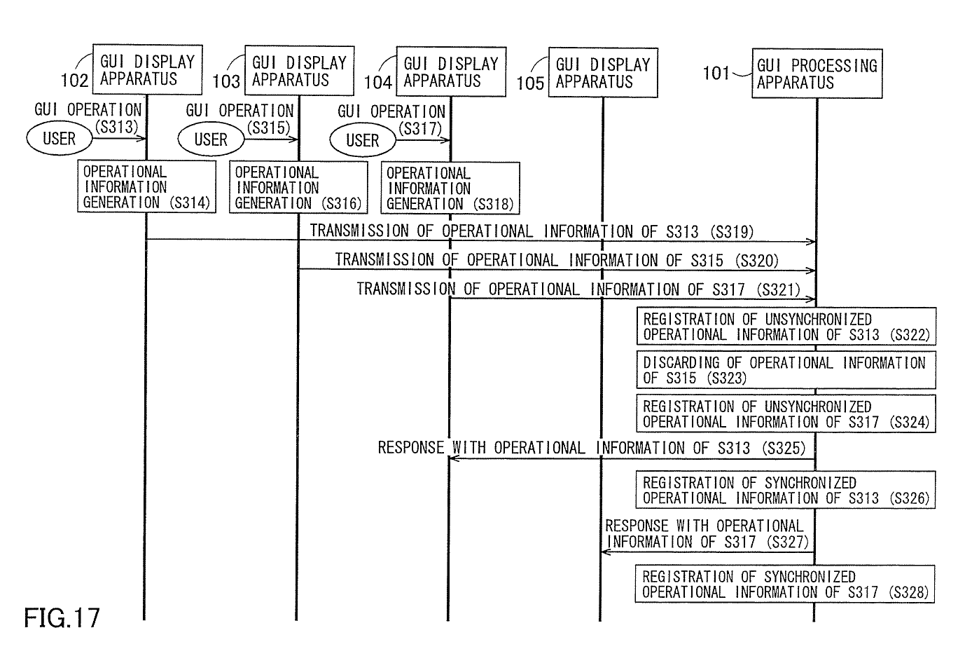

FIGS. 16 and 17 are sequence diagrams of process steps in basic principle of a GUI synchronous process in the third embodiment. Explained below are process steps for each GUI display apparatus 102 to acquire GUI information, and transmit and receive operational information. The explanation of the same steps as those of the first embodiment will be omitted.

The steps (S301 to S304) that the respective GUI information receivers 401 on the GUI display apparatuses 102, 103, 104, and 105 acquire GUI information from the GUI information transmitter 301 on the GUI processing apparatus 101 is the same as the GUI information acquisition process (steps S101 to S104) in FIG. 5 of the first embodiment.

Then, the transmitter 502, that is acquired by the GUI execution unit 405 by executing GUI information, requests for acquisition of synchronous-group information managed on the GUI processing apparatus 101 to the operational information receiver 302, by an HTTP GET method (step S305). The operational information receiver 302 acquires the currently-managed synchronous group information from the GUI synchronous information storage 307 via the GUI synchronous controller 304 (step S306) and transmits the result of acquisition to the receiver 503 (step S307).

Suppose that the GUI display apparatuses 102, 103, 104, and 105 acquire GUI information in this order. In the stage where the GUI display apparatus 102 has transmitted a synchronous-group acquisition request, no synchronous group exists. And hence, no synchronous-group information is included in a response with synchronous-group information.

A synchronous-group determination process on the GUI display apparatus 102 is a step of selecting whether to newly generate a synchronous group (step S308). This process may be achieved by displaying a GUI window for asking a user whether to newly generate a synchronous group. Or, the process may be achieved by automatic generation of a new synchronous group because no synchronous group exists.

In the succeeding stage where the GUI display apparatus 103 transmits a synchronous-group acquisition request, a synchronous group exists that has been generated by the GUI display apparatus 102. Therefore, the synchronous-group determination process in step S308 is achieved by displaying a GUI window for asking a user whether to synchronize the GUI display apparatus 102 and displayed contents or to operate a window independent of the GUI display apparatus 102 by generating a new synchronous group. Or, either option may be automatically determined based on a given criterion. It is supposed here that synchronization with the GUI display apparatus 102 has been selected.

Also in the succeeding GUI display apparatus 104, the same option as those of the GUI display apparatus 103 are displayed in step S308. It is supposed here that generation of a new synchronous group has been selected.

For the last GUI display apparatus 105, there are three options of selecting a synchronous group including the GUI display apparatuses 102 and 103, a synchronous group including the GUI display apparatus 104 only, and generation of a new synchronous group. It is supposed here that synchronization with the GUI display apparatus 104 has been selected.

Accordingly, in the stage where all GUI display apparatuses 102 have completed step S308, two groups, i.e. a synchronous group including the GUI display apparatuses 102 and 103, and a synchronous group including the GUI display apparatuses 104 and 105, are formed.

The succeeding connection establishing process from steps S309 to S312 is the same as the corresponding process (steps S105 to S108 in FIG. 5) of the first embodiment, hence the explanation thereof is omitted.

Described next with reference to FIG. 17 is a synchronous process for the contents to be displayed on GUI windows among a plurality of synchronous groups. Firstly, operations are performed simultaneously on the GUI display apparatuses 102, 103, and 104 to generate corresponding operational information that is then transmitted to the GUI processing apparatus 101 (step S313 to S321). In the same way as the first embodiment, the process of the GUI synchronous controller 304 has been serialized so that even if three pieces of operational information are simultaneously received by the operational information receiver 302, any one of the three is exclusively processed.

It is supposed here that the operational information is processed by the GUI synchronous controller 304 in order of the operational information of the GUI display apparatus 102, that of the GUI display apparatus 103, and that of the GUI display apparatus 104.

Firstly, the operational information of the GUI display apparatus 102 is registered in the GUI status information storage 306 as unsynchronized operational information (step S322). The operational information of the GUI display apparatus 103 to be processed next is discarded because unsynchronized operational information belonging to the same synchronous group as the GUI display apparatus 103 has already been registered (step S323). On the other hand, the operational information of the GUI display apparatus 104 is registered in the GUI status information storage 306 because unsynchronized operational information belonging to the same synchronous group has not been registered yet (step S324).

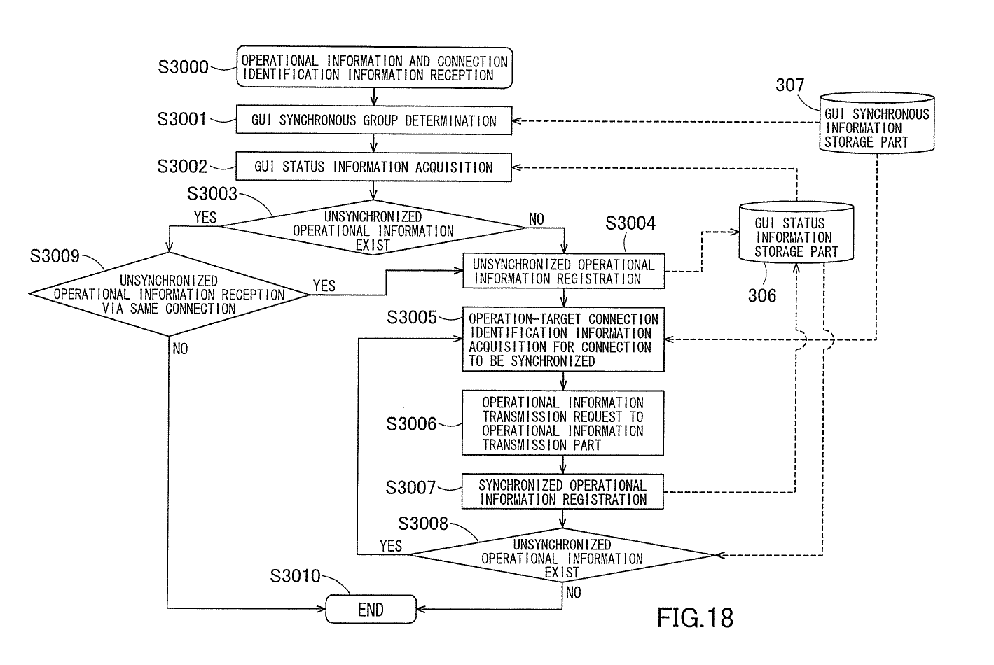

FIG. 18 is a flowchart showing the details of process steps of a GUI synchronous controller 304 in the third embodiment. In processing of the operational information from the GUI display apparatus 103, the GUI synchronous controller 304 acquires a synchronous-group identifier to which an apparatus to transmit the operational information belongs (step S3001). Next, the GUI synchronous controller 304 acquires unsynchronized information registered just before, by using the synchronous-group identifier as a key (step S3002). Acquired here is the operational information generated in step S313 of FIG. 17. When it is confirmed that unsynchronized operational information has already been registered (step S3003) and the acquired unsynchronized information is not the one transmitted from the apparatus corresponding to registered unsynchronized operational information (step S3009), the GUI synchronous controller 304 completes the process (step S3010), thus the operational information being discarded substantially. In contrast, in processing of the operational information from the GUI display apparatus 104, the unsynchronized operational information belonging to the synchronous-group identifier acquired in step S3001 cannot be acquired (step S3002). It is then determined as NO in a conditional branch in step S3003, and hence the operational information from the GUI display apparatus 104 is registered in the GUI status information storage 306 (step S3004).

Next, the GUI synchronous controller 304 transmits the operational information generated in step S313 to the GUI display apparatus 103 via the operational information transmitter 303 (step S325) and updates the mode of the corresponding operational information registered in the GUI status information storage 306 to “synchronized” (step S326). In the same way, the GUI synchronous controller 304 transmits the operational information generated in step S313 to the GUI display apparatus 105 via the operational information transmitter 303 (step S327) and updates the mode of the corresponding operational information registered in the GUI status information storage 306 to “synchronized” (step S328), and completes the process.

Finally, the consistency of the contents displayed on the GUI windows of the GUI display apparatuses 102, 103, 104, and 105 is kept.

As described above, according to the third embodiment, when there are a plurality of GUI display apparatuses 102, 103, 104, and 105, by grouping the apparatuses, a plurality of GUI windows having different layouts designed differently and operated differently, can be synchronized with one another for each group, while keeping the consistency of displayed data.

### Fourth Embodiment

In a fourth embodiment which will be described later, an insufficient portion of operation-target information is timely acquired from an operation-target information providing server apparatus (an operation-target information providing means).

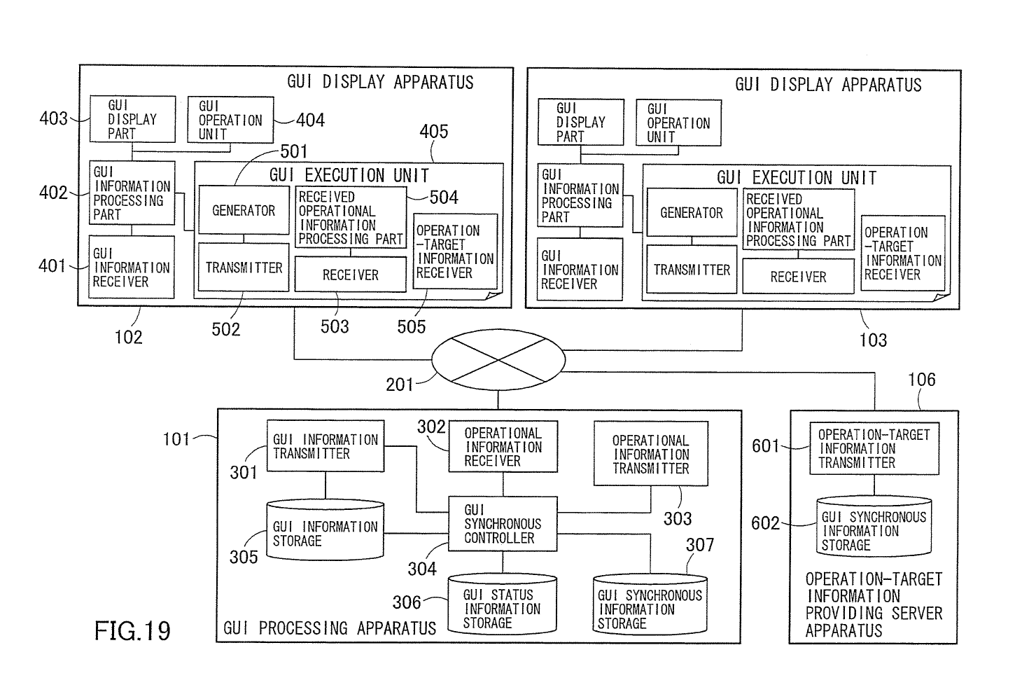

FIG. 19 is a functional block diagram schematically showing a GUI processing system having a GUI processing apparatus 101, according to the fourth embodiment. With respect to FIG. 19, the differences of the fourth embodiment from the first to third embodiments will be mainly explained.

A GUI processing apparatus 101 of FIG. 19 is provided with an operation-target information providing server apparatus 106 in addition to the configuration of the GUI processing apparatus 101 of FIG. 1. Concerning the hardware, this is the only one difference between FIG. 1 and FIG. 19.

The internal configurations of the GUI display apparatus 102 and the GUI processing apparatus 101 of FIG. 19 are basically identical to those of the GUI display apparatus 102 and the GUI processing apparatus 101 of FIG. 1, respectively. Nevertheless, a GUI execution unit 405 in the GUI display apparatus 102 has an operation-target information receiver 505. The operation-target information receiver 505 receives operation-target information from the operation-target information providing server apparatus 106.

The operation-target information providing server apparatus 106 stores operation-target information to be displayed on a GUI window and provides operation-target information. Practically, the operation-target information providing server apparatus 106 is a server apparatus for providing a contents distribution service on the Internet, an intermediate server apparatus for collecting contents from a variety of contents distribution services on the Internet and providing the contents related to a variety of services, a media server apparatus in conformity with the standard such as DLNA (Digital Living Network Alliance) existing on a home network, etc. In this embodiment, the operation-target information providing server apparatus 106 is a media server provided in a network 201 (LAN that forms a home network)

In function, the operation-target information providing server apparatus 106 has an operation-target information transmitter 601 and an operation-target information storage 602.

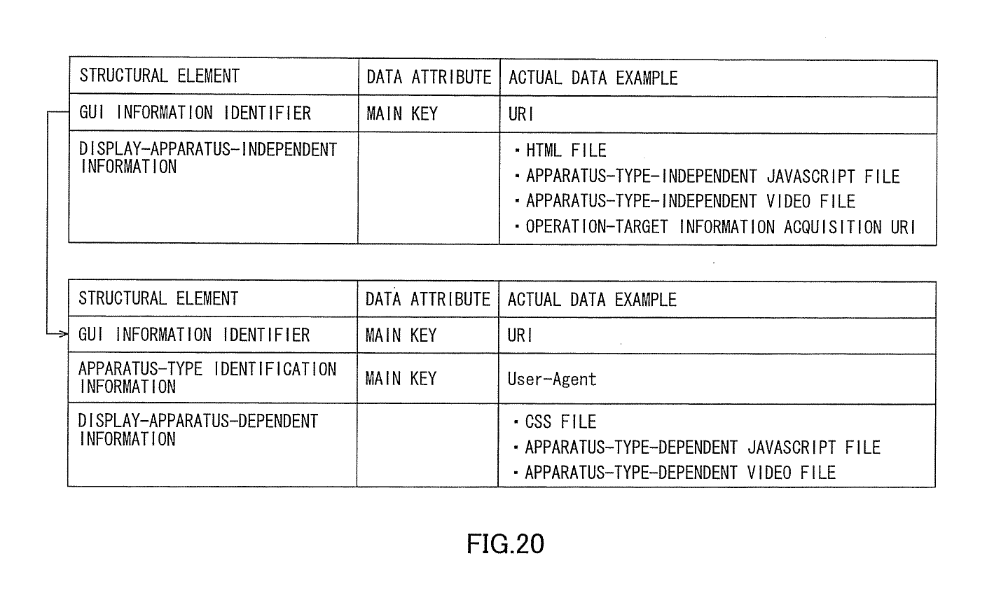

The GUI information storage 305 stores GUI information. FIG. 20 is a view showing an example of a data structure of GUI information according to the fourth embodiment. The GUI information of FIG. 20 includes an operation-target information acquisition URI in place of the operation-target information (video contents list) included in the GUI information in the first and second embodiments. By adopting the data structure of FIG. 20, the operation-target information itself can acquire information that is not supported by the GUI processing apparatus 101.

The operation-target information receiver 505 acquires operation-target information from the operation-target information transmitter 601 by using an operation-target information acquisition URI included in GUI information.

The operation-target information transmitter 601 provides operational information in response to a request included in GUI information and from the operation-target information receiver 505. Practically, the operation-target information transmitter 601 is, for example, an HTTP server, a Comet server or a WebSocket server. It is an HTTP server in this embodiment.

The operation-target information storage 602 stores operation-target information. The operation-target information is composed of information corresponding to contents lists (<div> data in content classes) in the example described in HTML in FIG. 8.

In this embodiment, a GUI-information acquisition process and a displayed-contents synchronization process to be performed between the GUI display apparatuses 102 and 103 are the same as those described in the first embodiment. The communications sequences between the apparatuses are in conformity with FIGS. 5 and 15. Likewise, the internal processes of the GUI information transmitter 303 and the GUI synchronous controller 304 are in conformity with FIGS. 6 and 10, respectively. This embodiment is different from the first to third embodiments in that operation-target information (a video contents list) is not included in GUI information provided by the GUI information transmitter 301.

In this embodiment, the GUI display apparatus 102 acquires operation-target information not at the GUI information receiver 401 but at the operation-target information receiver 505. There are roughly two first and second acquisition methods.

In the first method, after the competition of decoding of GUI information in FIG. 5 (step S104), the operation-target information receiver 505 transmits an operation-target information request (for example, an HTTP GET request) to an operation-target information acquisition URI included in the GUI information. When the request is received, the operation-target information transmitter 601 acquires the operation-target information that meets the request from the operation-target information storage 602 and transmits a response message (for example, an HTTP GET response) to the operation-target information receiver 505. It is supposed here that all operation-target information (100 video contents) are received.

In the second method, like the first method, after the competition of decoding of GUI information in FIG. 5 (step S104), the operation-target information receiver 505 acquires operation-target information. However, the second method is different from the first method in that information required for display only is acquired and cached, instead of acquiring every operation-target information as explained in the first method. For example, if a GUI window is the one shown in FIG. 9, there are five contents to be displayed. Then, the operation-target information receiver 505 firstly receives five data and displays them. And, after receiving operational information from another apparatus in FIG. 5 (step S120), the operation-target information receiver 505 timely acquires operation-target information to be newly required from the operation-target information providing server apparatus 106. The operation-target information receiver 505 may be configured to acquire required information only. Or, it may be configured to acquire operation-target information for a wider range than being displayed and cache them.

The foregoing is the characteristics of the fourth embodiment different from the first embodiment.

When moving-picture contents are to be operated, since there is a lot of operation-target information, it is difficult for the methods shown in the first to third embodiments to acquire all operation-target information in a practical processing time in acquisition of GUI information. For example, a large-scale moving-picture contents distribution service deals with several thousand to several one-hundred million contents.

In the method shown in this embodiment, each GUI display apparatus 102 collects operation-target information required only for display of a GUI window from the operation-target information providing server apparatus 106. Therefore, even if a main set of operation-target information is very large, GUI display apparatuses 102 can share operational information and keep the consistency of displayed contents within a practical processing time

As described above, according to the fourth embodiment, by using the GUI processing apparatus 101, it is possible to synchronize a plurality of GUI windows having different layouts designed differently and operated differently, while keeping the consistency of displayed data, even if the number of pieces of operation-target information is very large.

At least part of the information processing system explained in the embodiments may be configured with hardware or software. When it is configured with software, a program that performs at least part of the functions of the information processing system may be stored in a storage medium such as a flexible disk and CD-ROM, and then installed in a computer to run thereon. The storage medium may not be limited to a detachable one such as a magnetic disk and an optical disk but may be a standalone type such as a hard disk drive and a memory.

Moreover, a program that achieves the function of at least part of the information processing system may be distributed via a communication network (including wireless communication) such as the Internet. The program may also be distributed via an online network such as the Internet or a wireless network, or stored in a storage medium and distributed under the condition that the program is encoded, modulated or compressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A GUI processing apparatus, comprising:
an operational information receiver configured to receive first GUI operational information for operating a GUI window of a first GUI display apparatus;
a synchronous controller configured to generate second GUI operational information for a second GUI display apparatus comprising a GUI window operated synchronously in a state of keeping consistency with display information on the GUI window of the first GUI display apparatus when the GUI window of the first GUI display apparatus is operated based on the first GUI operational information; and
an operational information transmitter configured to transmit the second GUI operational information to the second GUI display apparatus.

2. The apparatus of claim 1, wherein the first or second GUI operational information comprises selection indicating information which selects information to be actually displayed on the GUI window among all the information capable of displaying on the GUI window and display order indicating information which indicates display order of the selected information.

3. The apparatus of claim 2, wherein the selection indicating information is information which directly selects a subset included in a portion of a main set of operation-target information for operating the GUI window, or information which selects a difference set from the subset displayed currently on the GUI window.

4. The apparatus of claim 2, further comprising a GUI status storage which stores GUI status information for specifying information actually displayed on the GUI window among all the information capable of displaying on the GUI window.

5. The apparatus of claim 4, further comprising a GUI information transmitter which transmits the GUI information and the GUI status information displayed on the GUI window of the first GUI display apparatus to the second GUI display apparatus when acquisition request of the GUI window of the first GUI display apparatus is received from the second GUI display apparatus.

6. The apparatus of claim 1, wherein the operational information receiver receives the first GUI operational information after a communication connection with the first GUI display apparatus is established, the communication connection continuing to be established even if reception of the first GUI operational information is finished, or the communication connection being cut off after reception of the first GUI operational information is finished and then the communication connection being again established.

7. The apparatus of claim 1, wherein the operational information transmitter transmits the second GUI operational information after the communication connection with the second GUI display apparatus is established, the communication connection continuing to be established even if transmission of the second GUI operational information is finished, or the communication connection being cut off after transmission of the second GUI operational information is finished and then the communication connection being again established.

8. The apparatus of claim 1, wherein the synchronous controller comprises:
an unsynchronized information register part configured to store unsynchronized GUI status information into the GUI status storage when the second GUI operational information in synchronization with the first GUI operational information is not generated;
an operational information generator configured to generate the second GUI operational information in synchronization with the first GUI operational information; and
a synchronized information register part configured to store synchronized GUI status information into the GUI status storage when the second GUI operational information is generated.

9. The apparatus of claim 1, wherein when the operational information receiver simultaneously receives the first GUI operational information from a plurality of GUI display apparatuses including the first and second GUI display apparatuses, the synchronous controller generates the second GUI operational information for one GUI display apparatus among the received plurality of GUI display apparatuses, and discards the received first GUI operational information for the other GUI display apparatuses.

10. The apparatus of claim 1, wherein:
a plurality of GUI display apparatuses including the first and second GUI display apparatuses are classified into two or more groups, each group comprising two or more GUI display apparatuses;
the synchronous controller generates GUI operational information for the GUI display apparatuses in each group; and
the operational information transmitter transmits the GUI operational information generated by the synchronous controller to the GUI display apparatuses in each group.

11. The apparatus of claim 1, wherein the synchronous controller acquires at least a portion of the second GUI operational information from an operation-target information providing part to generate the second GUI operational information.

12. A GUI processing method, comprising:
receiving first GUI operational information for operating a GUI window of a first GUI display apparatus;
generating second GUI operational information for a second GUI display apparatus comprising a GUI window operated synchronously in a state of keeping consistency with display information on the GUI window of the first GUI display apparatus when the GUI window of the first GUI display apparatus is operated based on the first GUI operational information; and
transmitting the second GUI operational information to the second GUI display apparatus.

13. The method of claim 12, wherein the first and second GUI operational information comprises selection indicating information which selects information to be actually displayed on the GUI window among all the information capable of displaying on the GUI window and display order indicating information which indicates display order of the selected information.

14. The method of claim 12, wherein the selection indicating information is information which directly selects a subset included in a portion of a main set of operation-target information for operating the GUI window, or information which selects a difference set from the subset displayed currently on the GUI window.

15. The method of claim 13, further comprising a GUI status storage which stores GUI status information for specifying information actually displayed on the GUI window among all the information capable of displaying on the GUI window.

16. The method of claim 15, further comprising a GUI information transmitter which transmits the GUI information and the GUI status information displayed on the GUI window of the first GUI display apparatus to the second GUI display apparatus when acquisition request of the GUI window of the first GUI display apparatus is received from the second GUI display apparatus.

17. The method of claim 12, wherein the operational information receiver receives the first GUI operational information after a communication connection with the first GUI display apparatus is established, the communication connection continuing to be established even if reception of the first GUI operational information is finished, or the communication connection being cut off after reception of the first GUI operational information is finished and then the communication connection being again established.

18. The method of claim 12, wherein the operational information transmitter transmits the second GUI operational information after the communication connection with the second GUI display apparatus is established, the communication connection continuing to be established even if transmission of the second GUI operational information is finished, or the communication connection being cut off after transmission of the second GUI operational information is finished and then the communication connection being again established.

19. The method of claim 12, wherein the synchronous controller comprises:
an unsynchronized information register part configured to store unsynchronized GUI status information into the GUI status storage when the second GUI operational information in synchronization with the first GUI operational information is not generated;
an operational information generator configured to generate the second GUI operational information in synchronization with the first GUI operational information; and
a synchronized information register part configured to store synchronized GUI status information into the GUI status storage when the second GUI operational information is generated.

20. A computer-readable storage medium which stores a program causing a computer to execute a GUI processing, the program comprising:
receiving first GUI operational information for operating a GUI window of a first GUI display apparatus;
generating second GUI operational information for a second GUI display apparatus comprising a GUI window operated synchronously in a state of keeping consistency with display information on the GUI window of the first GUI display apparatus when the GUI window of the first GUI display apparatus is operated based on the first GUI operational information; and
transmitting the second GUI operational information to the second GUI display apparatus.
